(19) United States
(12) Patent Application Publication
(10) Pub. No.: US 2026/0057219 A1
(43) Pub. Date: Feb. 26, 2026

(54) PERSONALIZED CONTENT GENERATION SYSTEM BASED ON USER INSIGHTS

(71) Applicant: Adobe Inc., San Jose, CA (US)

(72) Inventors: Lei ZHANG, Fremont, CA (US); Shengyun PENG, Sunnyvale, CA (US); Xirui WANG, Los Gatos, CA (US); Joy WANG, San Francisco, CA (US); Juliane LEITE DE SOUZA FLORES, San Francisco, CA (US); Jun HE, Fremont, CA (US); Zhenyu YAN, Cupertino, CA (US); David BERGER, San Jose, CA (US)

(21) Appl. No.: 18/813,793

(22) Filed: Aug. 23, 2024

(51) Int. Cl. G06N 3/0475; G06Q 30/0202

(52) U.S. Cl. CPC G06N 3/0475; G06Q 30/0202

(57) ABSTRACT

Some aspects relate to technologies for employing generative models to produce personalized content based on insights extracted from user data. In accordance with some aspects, user data for an end user is accessed, and a plurality of insights are extracted from the user data. A prompt is generated using at least a portion of the insights. The prompt is provided as input to a generative model, causing the generative model to generate content. A message based on the content from the generative model is provided to a user device of the end user.

### BACKGROUND

In the context of marketing, a content delivery system refers to a platform or set of tools designed to distribute digital marketing content over the Internet to target user devices effectively. This content can include for instance, emails, social media posts, in-app messages, and any other digital marketing content. Goals of content delivery systems include ensuring that the right content reaches the right audience at the right time and in the right format, and through the most appropriate channels.

### SUMMARY

Some aspects of the present technology relate to, among other things, using generative models to output text providing personalized content based on insights extracted from user data. In accordance with some aspects, user data for an end user is tracked and stored in a user data store. The user data can include, for instance, user behavior data (e.g., user activities with online resources) and user demographics. Insights are extracted from the user data using one or more data analysis techniques. A prompt is generated by using one or more rules and/or machine learning models to generate text for instructing a generative model to generate content based on the insights. The prompt is provided as input to a generative model, causing the generative model to generate content. A personalized message based on the content from the generative model is generated and provided to a user device of the end user.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a diagram illustrating examples of insights that can be extracted from user data in accordance with some implementations of the present disclosure;

FIG. 3 is a diagram illustrating an example of natural language text generated for a prompt from a collection of insights in accordance with some implementations of the present disclosure;

FIG. 4 is a block diagram illustrating an example pipeline for generating content based on extracted insights in accordance with some implementations of the present disclosure;

FIG. 5 is another block diagram illustrating an example pipeline for generating content based on extracted insights in accordance with some implementations of the present disclosure;

FIG. 6 is a flow diagram showing a method for generating a personalized message using extracted insights in accordance with some implementations of the present disclosure;

FIG. 7 is a flow diagram showing a method for refining content in accordance with some implementations of the present disclosure;

FIG. 8 is a flow diagram showing a method for performing an admin review of generated content in accordance with some implementations of the present disclosure;

FIG. 9 is a flow diagram showing a method for employing a message pool in accordance with some implementations of the present disclosure; and

FIG. 10 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, the term “user data” refers to information tracked and stored for an individual end user. The user data for a given individual includes user behavior data regarding the individual's online interactions (e.g., interactions with online resources, such as applications, marketing content, etc.). The user data for a given individual can also include user demographics (e.g., age, gender, geolocation, etc.).

The term “insight” is used herein to refer to information identifying a meaningful understanding, pattern, trend, correlation, or data relationship obtained by analyzing user data that can be used to inform decisions and actions. While user data can generally be considered as raw data, insights provide structured information from analysis of the raw data. By way of example only and not limitation, an insight can be in the form of: an attribute-value pair (e.g., purchase_frequency: high”); a statistical summary (e.g., mean, median, percentile, etc.); a pattern or trend (e.g., increased application usage); a cluster or segment (e.g., end user belongs to cluster Y); and narratives (e.g., text-based description of data analysis).

A “prompt” refers to text that is used as input to a generative model that instructs the generative model to produce specific content.

The term “content” is used herein to refer to text generated by a generative model in response to a prompt being input to the generative model.

In accordance with some aspects of the technology described herein, a “base prompt” refers to an initial prompt generated based at least in part on insights extracted from user data for an end user and input to a generative model. The content output from a generative model given a base prompt is referred to herein as “base content”.

In accordance with some aspects of the technology described herein, a “refinement prompt” refers to a prompt intended to refine content output from a generative model. The content output from a generative model given a refinement prompt is referred to herein as “refined content”.

The term “message” or “marketing message” is used herein to refer to a digital message generated using content from a generative model that is communicated over a network to a user device of an end user.

### Overview

Given the vast number of user devices and the incredible amount of content distributed on the Internet, automating the delivery of content to user devices poses a technical challenge for content delivery systems. Conventional content delivery systems use a number of approaches to automate the delivery of content to user devices. For instance, one approach is fixed-content batch delivery. Batch delivery is likely one of the oldest and simplest methods. In this method, batches of messages are distributed over the Internet to user devices. The message contents are often the same across all the recipients. The major disadvantage for this method is that batch delivery is not adaptive to different end users. In other words, conventional batch delivery approaches are unable to provide personalized content to different end users and therefore fail to account for the fact that different end users have different personal interests.

Another conventional approach is to use template-based content. In this approach, the content delivery system adds content to templates to generate messages that are then distributed over the Internet to user devices. Template-based approaches are typically more advantageous than batch delivery as the templates allow the content to be varied between different recipients. However, there are several disadvantages to template-based approaches. The first disadvantage is inadequate customization. Templates often do not provide enough customization options to tailor the content to specific needs. Another disadvantage is inflexibility. Templates can be limiting in terms of structure, tone, and voice. As a result, templates may not fit the unique needs and goals of a marketing campaign and/or the templates can make the content feel stiff and impersonal. A further disadvantage is poor quality. The passages generated by templates usually lack concurrency and a clear connection to the point that it is meant to support.

Aspects of the technology described herein improve the functioning of the computer itself in light of these shortcomings in existing technologies by providing an improved content generation system that generates and delivers personalized content to end user devices. In accordance with some aspects, insights are extracted from user data, and the insights are used to construct prompts to cause a generative model to produce text that provides content for generating personalized messages.

In operation, the content generation system tracks user data for end users. The user data for an end user can include, for instance, user behavior data (e.g., data regarding user interactions with online resources, such as websites and applications) and user demographics (e.g., gender, age, geolocation, etc.). For a given end user, the content generation system extracts insights from the user data for the end user. The insights are extracted using one or more data analysis techniques, such as, for instance: descriptive analysis, exploratory analysis, diagnostic analysis, predictive analysis, prescriptive analysis, quantitative analysis, aggregation, segmentation, pattern recognition, and machine learning. The content generation system uses the extracted insights to generate a prompt. In some cases, one or more rules and/or machine learning models are employed to map certain insights to particular text for the prompt. The content generation system provides the prompt as input to a generative model, causing the generative model to produce content. The content generation system generates a personalized message based on content from the generative model and communicates the personalized message over a network to a user device of the end user.

In some aspects, two or more iterations are performed to refine the content. For instance, a base content can initially be generated using a base prompt. The base content is evaluated to determine if requirements associated with the insights are satisfied. If not, a refinement prompt is generated that instructs the generative model to refine the base content to satisfy one or more requirements. The refinement prompt is provided as input to the generative model, causing the generative model to produce refined content.

In some cases, the content generation system facilitates review by an administrative user. In particular, the content generation system provides one or more user interfaces to a user device of an administrative user to review content generated by the content generation system. The administrative user can provide input approving the content or rejecting the content (with or without additional information to refine the content). If rejected, the content generation system refines the content, for instance, using any additional information provided by the administrative user.

The content generation system also employs a message pool in some configurations to store messages provided to end users. In some aspects, each message is stored in association with insight data for insights used to construct the message. This allows for previously-generated messages to be used for similar end users, as opposed to generating new messages for all end users. When a message is to be provided to an end user, insight data is extracted from user data for the end user, and the insight data is used to query the message pool. If stored insight data with threshold similarity is identified, the message stored in the message pool in association with that stored insight data is retrieved and used to provide a message to the end user. Alternatively, if stored insight data with threshold similarity is not identified, the process of generating a prompt based on the insights and causing a generative model to produce content using the prompt is employed to generate a message for the end user.

Aspects of the technology described herein provide a number of improvements over existing technologies. For instance, the technology described herein provides a computer-based pipeline for processing user data to generate personalized messages by leveraging insights extracted from the user data and a generative model to generate text given a prompt based on those insights. Compared with conventional content delivery systems (e.g., using batch delivery or template methods), the technology described herein enables the automated generation and delivery of content that is personalized to each end user. The rules and machine learning models used to extract insights and generate prompts from the insights also provide for more consistent and accurate content generation. The use of a message pool further provides improvements, as it allows for previously-generated personalized messages to be reused for similar end users, thereby conserving computer resource consumption. Using extracted insights to identify similar users also ensures that when messages from the message pool are employed, the messages are tailored to the end users.

### Example System for Personalized Content Generation

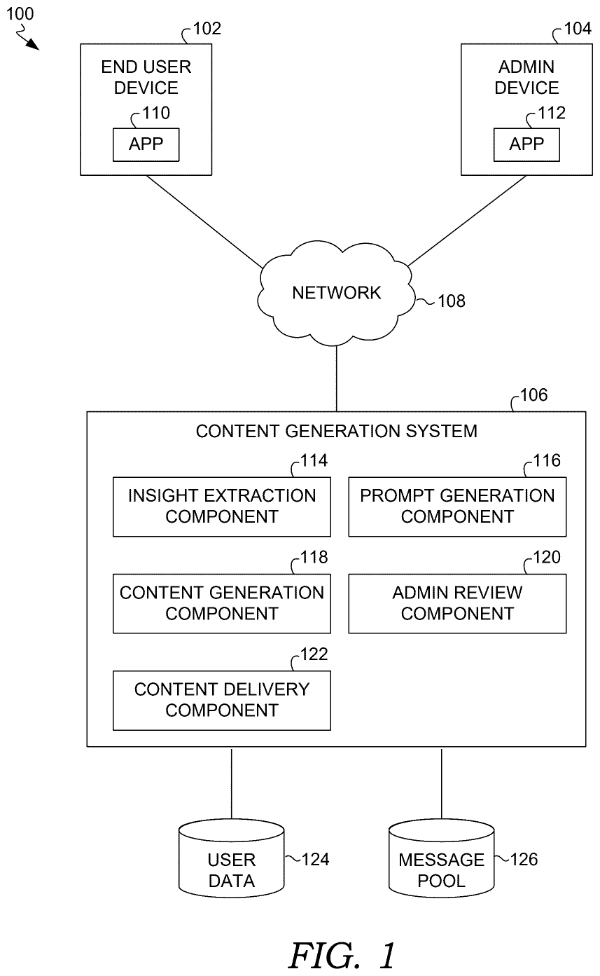

With reference now to the drawings, FIG. 1 is a block diagram illustrating an exemplary system 100 that for generating personalized content based on insights extracted from user data in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

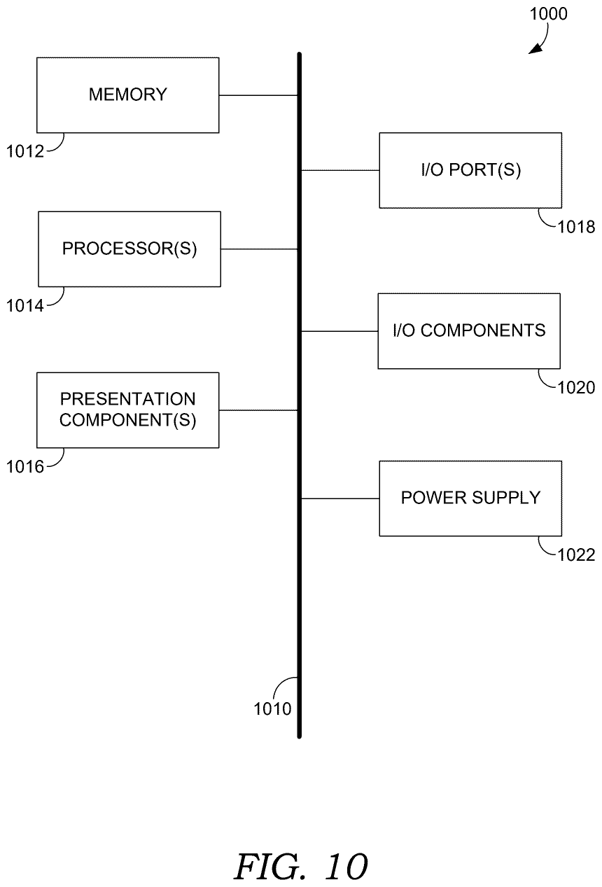

The system 100 is an example of a suitable architecture for implementing certain aspects of the present disclosure. Among other components not shown, the system 100 includes an end user device 102, an admin device 104, and a content generation system 106. Each of the end user device 102, the admin device 104, and the content generation system 106 shown in FIG. 1 can comprise one or more computer devices, such as the computing device 1000 of FIG. 10, discussed below. As shown in FIG. 1, the end user device 102, the admin device 104, and the content generation system 106 can communicate via a network 108, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the content generation system 106 could be provided by multiple server devices collectively providing the functionality of the content generation system 106 as described herein. Additionally, other components not shown may also be included within the network environment.

The end user device 102 and the admin device 104 can each be a client device on the client-side of operating environment 100, while the content generation system 106 can be on the server-side of operating environment 100. The content generation system 106 can comprise server-side software designed to work in conjunction with client-side software on the end user device 102 and the admin device 104 so as to implement any combination of the features and functionalities discussed in the present disclosure. For instance, the end user device 102 can include an application 110 and the admin device 104 can have an application 112 for interacting with the content generation system 106. The application 110 and the application 112 can each be, for instance, a web browser or a dedicated application for providing functions, such as those described herein. This division of operating environment 100 is provided to illustrate one example of a suitable environment, and there is no requirement for each implementation that any combination of the end user device 102, the admin device 104, and/or the content generation system 106 remain as separate entities. While the operating environment 100 illustrates a configuration in a networked environment with a separate end user device, admin device, and content generation system, it should be understood that other configurations can be employed in which aspects of the various components are combined. For instance, in some aspects, aspects of the content generation system 106 can be implemented in part or in whole by the end user device 102 and/or the admin device 104.

The end user device 102 and the admin device 104 can each comprise any type of computing device capable of use by a user. For example, in one aspect, the end user device 102 and the admin device 104 may each be the type of computing device 1000 described in relation to FIG. 10 herein. By way of example and not limitation, the end user device 102 and the admin device 104 can each be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. An end user can be associated with the end user device 102 and can interact with the content generation system 106 via the end user device 102. An administrative user can be associated with the admin device 104 and can interact with the content generation system 106 via the admin device 104.

The content generation system 106 generates personalized content for end users, such as an end user associated with the end user device 102, by extracting insights from user data collected for each end user, generating a prompt using the extracted insights for each end user, and using the prompt to cause a generative model to output personalized content for each end user. As shown in FIG. 1, the content generation system 106 includes an insight extraction component 114, a prompt generation component 116, a content generation component 118, an admin review component 120, and a content delivery component 122. The modules/components of the content generation system 106 may be in addition to other components that provide further additional functions beyond the features described herein. The content generation system 106 can be implemented using one or more server devices, one or more platforms with corresponding application programming interfaces, cloud infrastructure, and the like. While the content generation system 106 is shown separate from the end user device 102 and the admin device 104 in the configuration of FIG. 1, it should be understood that in other configurations, some or all of the functions of the content generation system 106 can be provided on the end user device 102 and/or the admin device 104. Additionally, in some configurations, one or more of the components of the content generation system 106 shown in FIG. 1 can be provided by the end user device 102, the admin device 104, and/or another location not shown in FIG. 1. The components can be provided by a single entity or multiple entities.

In some aspects, the functions performed by components of the content generation system 106 are associated with one or more applications, services, or routines. In particular, such applications, services, or routines may operate on one or more user devices, servers, may be distributed across one or more user devices and servers, or be implemented in the cloud. Moreover, in some aspects, these components of the content generation system 106 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The insight extraction component 114 extracts insights for individual end users based on user data tracked for each individual and stored in the user data store 124. The user data for a given individual includes user behavior data regarding user activities interacting with online resources (e.g., applications, marketing content, etc.). The user data for a given individual can also include user demographics (e.g., age, gender, geolocation, etc.). By analyzing the user data available for individuals in the user data store 124, the insight extraction component extracts a full picture of insights for each individual, including but not limited to: interested items/app functions, app usage patterns, unfamiliar items/app functions, application usage engagement trends, conversion probability, and retention probability.

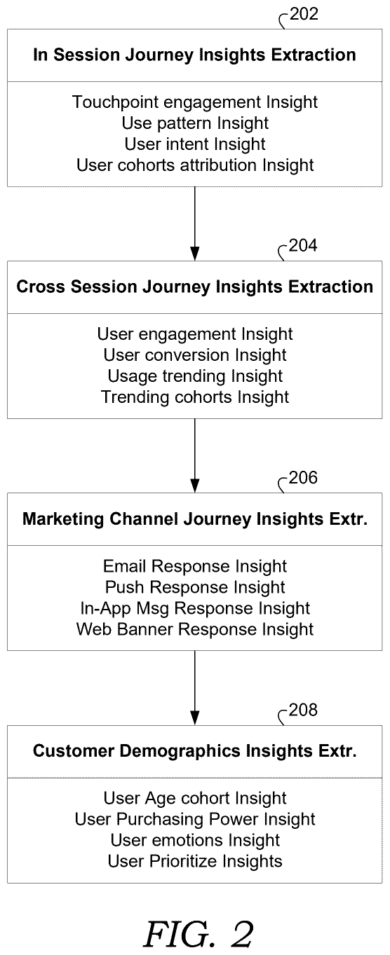

FIG. 2 provides an example of insights that can be extracted from user data by the insight extraction component 114. As shown in FIG. 2, the insights include in-session insights 202, cross-session insights 204, marketing channel insights 206, and user demographics insights 208. The in-session insights 202 include insights gleaned from user activities in a given session, such as touchpoint engagement, use pattern, user intent, and user cohorts attribution insights. The cross-session insights 204 include insights gleaned from user activities across multiple sessions, such as user engagement, user conversion, usage trending, and trending cohorts insights. The marketing channel insights 206 include insights gleaned from user activities associated with particular marketing channels, such as email response, push response, in-app message response, and web banner response insights. The user demographics insights 208 include insights gleaned from user demographics, such as user age cohort, user purchasing power, user emotions, and user prioritization insights.

The insight extraction component 114 comprises a computer program that employs a number of technical steps and methodologies to extract insights from user data. Initially, the insight extraction component 114 (or another component not shown) collects user data from various sources, such as, for instance, websites, applications, and user devices. As noted above, the collected data can include user behavior data regarding user activities and/or user demographics. The collected data is stored in the user data store 124. In some aspects, one or more data preprocessing steps are performed on the raw user data, such as, for instance: cleaning the data by removing duplicates, handling missing values, and correcting errors; normalizing the data to ensure it is an appropriate format; and performing feature engineering. Given the user data, the insight extraction component 114 performs data analysis techniques in order to gain meaningful insights from the user data. The data analysis techniques, can include, for instance: descriptive analysis, exploratory analysis, diagnostic analysis, predictive analysis, prescriptive analysis, quantitative analysis, aggregation, segmentation, pattern recognition, and machine learning.

The insights extracted for a given individual by the insight extraction component 114 are provided to the prompt generation component 116, which translates the insights into natural language text as a prompt for input to the downstream content generation component 118 for generating a personalized message. In addition to insights extracted by the insight extraction component, the prompt generation component 116 can take as input data including but not limited to: domain knowledge (e.g., product features, app pages layout, features included in the paid subscription, tutorial URLs, etc.) and possible marketing actions (e.g., in-app or email message type, personalized promotion rate ranges, new features of app, trending features/posts in the community, etc.). In some aspects, based on these inputs, the prompt generation component 116 learns and calculates a rank of the message main purposes and generates the prompt based on that determination. The message main purposes can include, for instance, persuade non-paid customer conversion, encourage engagement for paid customers, and app feature introduction and tutorial recommendation.

The prompt generation component 116 comprises a computer program that generates human natural language sentences that can use rich descriptive language while specifying the desired response criteria for the downstream content generation component 118. In some aspects, the computer program comprises rules and/or machine learning models that map certain aspects of the input, including the insights extracted by the insight extraction component 114, to natural language text and/or that generates natural language text for the prompt language based on the inputs. For instance, in some cases, the prompt generation component 116 uses rules that map certain values for attribute-value pairs to certain text for the prompt.

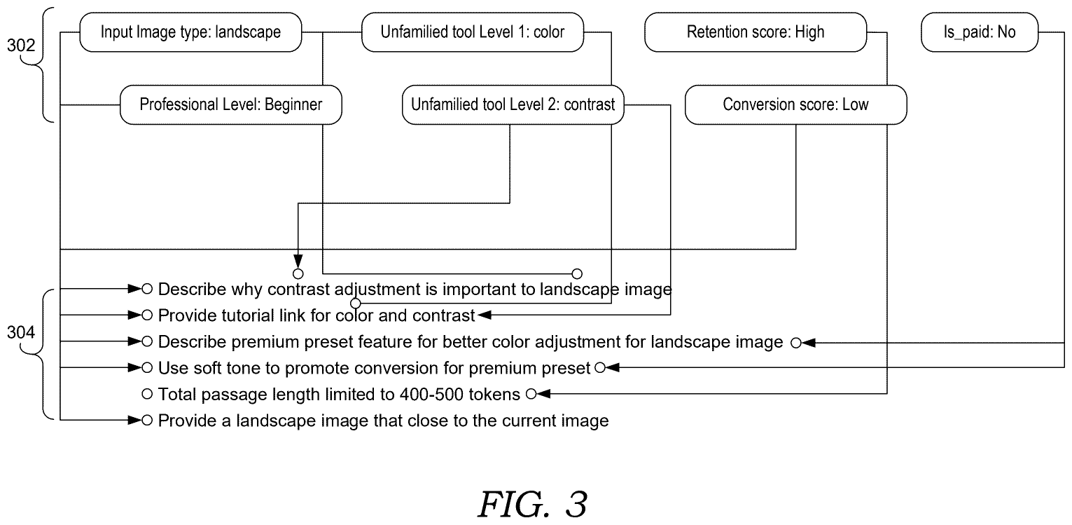

By way of example to illustrate, FIG. 3 shows natural language text 304 for a prompt generated from a collection of insights 302. In the example of FIG. 3, each insight comprises an attribute-value pair that specifies an attribute and a value for that attribute. For instance, the attribute-value pair “Retention score: High” indicates a value of “High” for the attribute “Retention score”. The lines from the insights 302 to portions of the natural language text 304 shown in FIG. 3 indicate which insights resulted in the various portions of the text being generated. For instance, the text “Total passage length limited to 400-500 tokens” has been generated based on the attribute-value pair “Retention score: High”. A different value for that attribute-value pair (e.g., “Low”) could result in different text being generated.

The prompt provided by the prompt generation component 116 is used as input to the content generation component 118, which employs a generative model to generate natural language text based on the prompt. The generative model used by the content generation component 118 can comprise a language model that includes a set of statistical or probabilistic functions to perform Natural Language Processing (NLP) in order to understand, learn, and/or generate human natural language content. For example, a language model can be a tool that determines the probability of a given sequence of words occurring in a sentence or natural language sequence. Simply put, it can be a model that is trained to predict the next word in a sentence. A language model is called a large language model (LLM) when it is trained on enormous amount of data and/or has a large number of parameters. Some examples of LLMs are GOOGLE's BERT and OpenAI's GPT-3 and GPT-4. These models have capabilities ranging from writing a simple essay to generating complex computer codes-all with limited to no supervision. Accordingly, an LLM can comprise a deep neural network that is very large (e.g., billions to hundreds of billions of parameters) and understands, processes, and produces human natural language by being trained on massive amounts of text. These models can predict future words in a sentence letting them generate sentences similar to how humans talk and write or otherwise in a form dictated, for instance, by a prompt.

In accordance with some aspects, the generative model used by the content generation component 118 comprises a neural network. As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some configurations, the generative model used by the content generation component 118 is a pre-trained model (e.g., GPT-4) that has not been fined-tuned. In other configurations, the generative model is a model that is built and trained from scratch or a pre-trained model that has been fine-tuned. In such configurations, the generative model can be trained or fine-tuned using training data. During training, weights associated with each neuron can be updated. Originally, the generative model can comprise random weight values or pre-trained weight values that are adjusted during training. In one aspect, the generative model is trained using backpropagation. The backpropagation process comprises a forward pass, a loss function, a backward pass, and a weight update. This process is repeated using the training data. The goal is to update the weights of each neuron (or other model component) to cause the generative model to produce useful natural language text when given prompts. Once trained, the weight associated with a given neuron can remain fixed. The other data passing between neurons can change in response to a given input. Retraining the network with additional training data can update one or more weights in one or more neurons.

In some aspects, the prompt generation component 116 generates a prompt for input to the downstream content generation component 118 a single time, and the content from the content generation component 118 is used to provide a marketing message to an end user. In other aspects, the prompt generation component 116 and content generation component 118 can perform two or more iterations of prompt generation and content generation before providing a marketing message to an end user. In instances of multiple iterations, the prompt generation component 116 initially generates a base prompt using insight data from the insight extraction component 114, and also possibly using domain knowledge and/or marketing actions. As an example, the input to the prompt generation component 116 to generate a base prompt could be:

product_features = {“product”: “Lightroom Mobile”, “purpose”:
“conversion”, “message_type”: “push_notification”, “emoji”:
“true”, “features”: {“Premium presets”: {“highlights”: [“over-150
presets”, “professional results”, “easy to apply”, ...], “description”:
[“While capturing photos, being too close to the subject or using
certain types of lenses can distort perspective and make straight lines
appear bowed, tilted or skewed in your photos. For example,
shooting up at a tall building can make the building look like it's
leaning away from you. You can easily fix and adjust the perspective
of your photo using the Upright modes and geometry slider tools in
the Geometry panel.”, ...], ...}, “Geometry tools”: {“highlights”:
[“easy to use”, “correct distortion”, “correct horizontal”, ...],
“description”}, “Healing brush”: {“highlights”: [...], “description”:
..., ...}, ...}}
user_insights = {user_interest: “premium presets”,
“conversion_probability”: “high”, “most_used_free_features”:
[“color”, “white_balance”], “paid”: “false”, ...}

Given this input, the prompt generation component 116 could generate the following base prompt:
“Assume you are a marketing assistant for Lightroom Mobile app and you are helping to write marketing messages to attract user open app, engage and finally subscribe to the service. Write a message to a free/unpaid user who has tried the premium presets tool and has high conversion probability. The premium presets tool is one of the premium features in the subscription service. The general description for premium preset is ‘In the Premium tab, you can find industry-standard presets for an array of edits, including Portraits for different skin tones, Travel, Cinematic, Vintage, and more. Tap a preset to apply the edits to the image. New presets are added with each update.’ Emphasize the ease of use, professional results, and over 150 available highlights of the premium presets tool.”

Once the base prompt is built by the prompt generation component 116, it is sent to the generative model of the content generation component 118, which generates base content. For instance, given the base prompt example above, the generative model could provide the following base content:
“Subject: Elevate Your Editing Game with Premium Presets! Dear Lightroom Mobile Enthusiast,
We hope you've been enjoying your creative journey with Lightroom Mobile's Premium Presets tool!
Our Premium Presets are designed to make your editing experience effortless, while delivering professional-quality results that truly stand out. Whether you're capturing portraits, travel adventures, or cinematic moments, we've got you covered with over 150 industry-standard presets, and we're constantly adding more with each update.
Here's why our Premium Presets are a game-changer:
Easy as 1-2-3: No more struggling with complex editing settings.
With a single tap, you can transform your photos into stunning works of art. It's editing made simple, so you can focus on what you love-capturing incredible moments.
Professional Perfection: Unlock the secrets of top-notch photography with presets designed by experts. Achieve the perfect skin tone in portraits, capture the essence of your travels, or infuse your shots with cinematic flair. Your photos will radiate professionalism effortlessly.
150+ Presets and Counting: With a diverse array of presets at your fingertips, your creativity knows no bounds. From vintage vibes to contemporary cool, we've got presets for every mood and moment.
Explore, experiment, and be amazed!
Ready to take your editing skills to the next level? Upgrade to Lightroom Mobile's Premium Subscription now and enjoy unlimited access to the Premium Presets tool, along with many more exclusive features. Elevate your photography game and bring your vision to life!
Tap the button below to unlock your creative potential:
[Upgrade Now]
Thank you for being a part of the Lightroom Mobile community.
We can't wait to see the incredible images you'll create with our
Premium Presets!
Happy Editing and Happy Capturing!
Best regards,
[Your Name]
The Lightroom Mobile Team”

Given the base content, the prompt generation component 116 generates a refinement prompt for refining the base content. The refinement prompt can include descriptive phrases and sentences to cause the generative model to change the base content, for instance, to emphasize the marketing action and add variation requirements, such as a personalized tone change to the end user. In some aspects, the prompt generation component 116 generates the refinement prompt by analyzing the base content to determine if the base content satisfies certain requirements dictated by the insights extracted for the end user. For instance, in the example of FIG. 3, one requirement determined from the insight “Is paid: No” is to “Use soft tone to promote conversion for premium preset.” The prompt generation component 116 could analyze the base content to determine if it contains a soft tone, and if not, the prompt generation component 116 can build the refinement prompt to instruct the generative model to modify the base content to soften the tone.

By way of illustration using the above example base content, the prompt generation component 116 could determine to modify the base content to a short push notification message within 30 words, and given that the user has high conversion probability, to use more intense marketing phrases to persuade conversion. Based on this determination, the prompt generation component could build the following refinement prompt: “Rewrite the [above message] into a push notification-like message that targets a high conversion probability customer by using more intensive marketing phrases. Use 30 words at most.”

Once the refinement prompt is constructed by the prompt generation component 116, it is sent to the generative model of the content generation component 118, which generates refined content based on the refinement prompt. For instance, given the above example refinement prompt, the following refined content could be generated:

“Unleash Pro Editing! Elevate pics with 150+ Premium Presets!
Effortless pro results in 1 tap. Upgrade now for endless creativity!
#LightroomPro”

The above-described process of generating a refinement prompt and using the refinement prompt to generate refined content can be iterated any number of times before using the content to generate a marketing message that is communicated to a user device, such as the end user device 102.

In some aspects, content generated by the content generation component 118 (i.e., base content in the case of a single prompt/content generation step, or refined content in the case of two or more iterations) can be reviewed by an administrative user prior to using the content to generate a marketing message to be sent to a user device. Accordingly, the content generation system 106 includes an admin review component 120 to facilitate review of generated content by an administrative user. The admin review component 120 provides one or more user interfaces to an admin device, such as the admin device 104. The user interfaces provide the generated content for presentation by the admin device 104. The user interfaces can also provide additional context, such as the extracted insights, any requirements determined based on the insights, relevant domain knowledge, relevant marketing actions, and/or prompt(s) used to generated the content.

The user interfaces allow an administrative user to perform a quality control step, for instance, to check if the generated content meets requirements based on the extracted insights and aligns with the brand value. The user interfaces also allow the administrative user to provide input, such as approving or rejecting the generated content. If an approval input is received by the admin review component 120, a marketing message can be generated based on the content and communicated to a user device. Alternatively, if a rejection input is received by the admin review component 120, another refinement prompt can be generated by the prompt generation component 116 and provided to the generative model of the content generation component 118 to generate further refined content. In some aspects, the user interfaces allow the administrative user to input instructions for use in generating the refinement prompt.

The content delivery component 122 communicates marketing messages over the network 108 to user devices, such as the end user device 102, based generated content (with or without admin review). The content delivery component 122 determines a type of marketing message (e.g., email, push notification, in-app message, web banner, etc.) or multiple types of marketing messages for a given content. For instance, in some aspects, the content generated by the content generation component 118 is identified as intended for a particular type of marketing message. The content delivery component 122 then generates marketing message(s) of the determined type(s) using the generated content and communicates the marketing message(s) over the network 108 to a user device, such as the end user device 102, using the communication channel(s) appropriate for each type of marketing message.

In some aspects, after a marketing message is generated, it is stored in a message pool data store 126. The message pool data store 126 can serve several purposes. For instance, in some aspects, the message pool data store 126 can store generated marketing messages so that they can be sent to other end users with similar insights. This avoids the process of marketing message generation in instances of end users with similar insights. In such configurations, each marketing message is stored in association with data used to generate the content of the marketing message. This could include, for instance, data regarding the insights that were extracted and used to generate the content. Accordingly, when insights are extracted for another end user, the insights can be compared against insight data stored in the message pool data store 126. If there is insight data in the message pool data store 126 that is sufficiently similar to the insight data for the current end user (e.g., the insight data from the message pool data store 126 and insight data for the current user meets a similarity threshold), the marketing message associated with that insight data in the message pool data store 126 is retrieved and communicated over the network 108 to the user device via the content delivery component 122.

In some aspects, a vector representation of the insights used to generate the content of each marketing message is generated and stored in association with each marketing message. As such, when insights are extracted for a current end user to provide marketing content to the current end user, a vector representation of those insights is generated and compared against stored vector representations. Each vector representation can comprise, for instance, an embedding provided by a machine learning model give a set of insights. The vector representation of insights for a current end user can be compared against stored vector representations using a similarity function, such as cosine similarity, that provides a similarity score. If the similarity score for a vector representation for the current end user and a stored vector representation meets a similarity score threshold, the marketing message stored in the message pool data store 126 in association with that vector representation is retrieved and provided to the user.

The message pool data store 126 can also maintain the delivery history of marketing messages to individual end users. In such aspects, when a marketing message is generated for a given end user, a user identifier of that end user is stored in the message pool data store 126 in association with the stored marketing message. Among other things, this helps to track user experiences and provide the end users with better and more precise recommendations over the whole customer relationship time span.

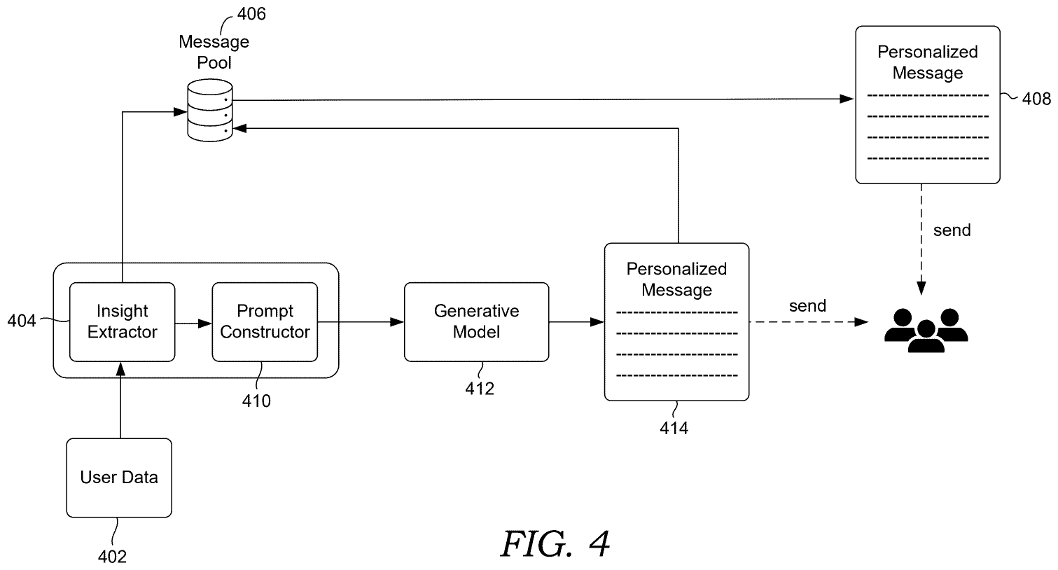

With reference now to FIG. 4, a block diagram is provided showing a pipeline 400 for generating content based on extracted insights in accordance with some configurations. As shown in FIG. 4, user data 402 is received. The user data 402 is processed by an insight extractor 404 (which can correspond to the insight extraction component 114 of FIG. 1) to extract insights. In accordance with the pipeline 400, the extracted insights are compared against insight data in a message pool 406 (which can correspond to the message pool data store 126 of FIG. 1). This can include, for instance, generating a vector representation of the extracted insights and comparing that vector representation against vector representations of insights used to generate marketing messages stored in the message pool 406. If the extracted insights are sufficiently similar to a particular insight data in the message pool, the marketing message stored in association with that insight data is retrieved, and a personalized message 408 based on the marketing message is sent to the user.

If the message pool 406 does not store insight data sufficiently similar to the extracted insights, the extracted insights are provided to a prompt constructor 410 (which can correspond to the prompt generation component 116 of FIG. 1). The prompt constructor 410 generates a prompt based on the extracted insights and, in some cases, based on additional data, such as relevant domain knowledge and marketing actions. The prompt is provided to a generative model 412 (which can correspond to the generative model of the content generation component 118 of FIG. 1), which generates content. A personalized message 414 is generated using the content and sent to the user. In some aspects, although not shown in FIG. 4, the pipeline 400 can include multiple iterations of prompt generation by the prompt constructor 410 and content generation by the generative model 412 prior to generating and sending the personalized message 414. Additionally, in some aspects, although not shown in FIG. 4, the pipeline 400 can include admin review (and possible content refinement based on the admin review) prior to generating and sending the personalized message 414.

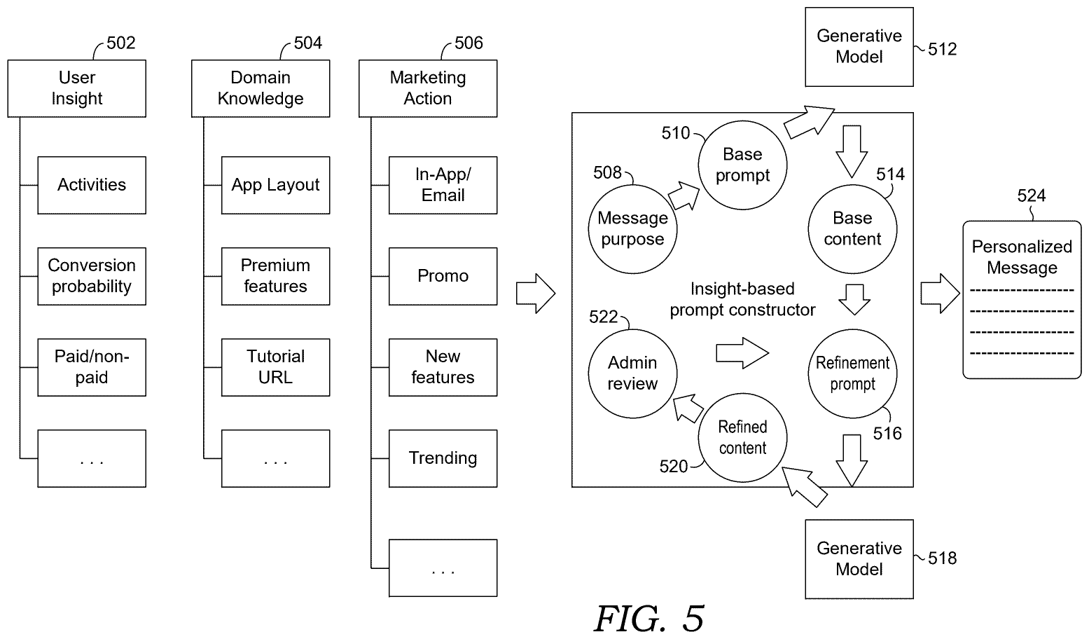

Turning next to FIG. 5, a block diagram is provided showing another pipeline 500 for generating content based on extracted insights in accordance with some configurations. In the example of FIG. 5, the input includes user insights 502, domain knowledge 504, and marketing actions 506. Given this input, one or more message purposes 508 are determined and a base prompt 510 is generated. The base prompt 510 is provided as input to a generative model 512, which generates base content 514. A refinement prompt 516 is generated to refine the base content 514 (e.g., from analysis of the base content 514 relative to requirements identified based on the user insights 502, domain knowledge, and/or marketing actions 506). The refinement prompt 516 is provided as input to a generative model 518 (which could be the same model as generative model 512), which generates refined content 520. The refined content 520 is provided to an administrative user for admin review 522. Once the content has been approved, a marketing message 524 is generated from the content.

### Example Methods for Personalized Content Generation

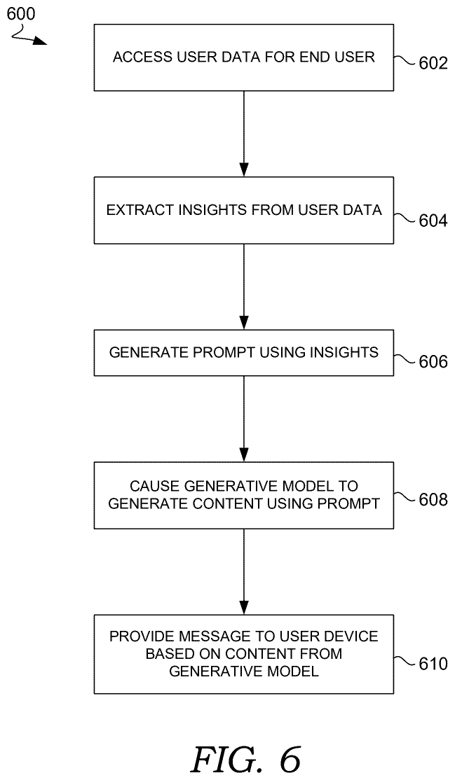

With reference now to FIG. 6, a flow diagram is provided that illustrates a method 600 for generating a personalized message based on extracted insights for a given end user. The method 600 may be performed, for instance, by the content generation system 106 of FIG. 1. Each block of the method 600 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 602, user data for an end user is accessed. The user data can comprise, for instance, user behavior data and/or user demographics. Insights are extracted from the user behavior data, as shown at block 604. For instance, the insight extraction component 114 of FIG. 1 could execute code that performs one or more data analysis techniques to identify insights from the user data.

A prompt is generated using the insights, as shown at block 606. For instance, the prompt generation component 116 of FIG. 1 could execute code that executes rules and/or employs a machine learning model to generate text with instructions for generating content based on the insights. In some aspects, other information, such as domain knowledge and/or marketing actions, are used in conjunction with the insights to generate the prompt.

As shown at block 608, a generative model is caused to generate content using the prompt. For instance, the content generation component 118 of FIG. 1 could provide the prompt as input to the generative model to cause the generative model to output text. Although not shown in FIG. 6, the process or generating a prompt at block 606 and using the prompt to generate content at block 608 can be repeated any number of times. As shown at block 610, the content is used to generate a personalized message that is provided, for instance over a network, to a user device for presentation.

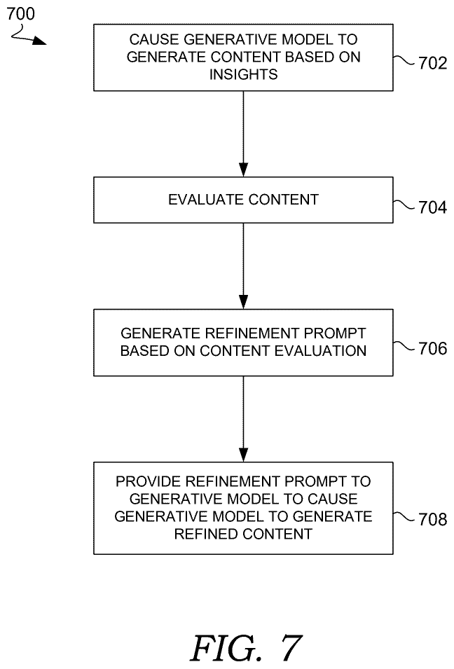

FIG. 7 is a flow diagram showing a method 700 for refining content from a generative model. As shown at block 702, a generative model is caused to generate content based on extracted insights. This could be, for instance, base content generated in accordance with blocks 604, 606, and 608 of FIG. 6, or refined content generated by the generative model refining previously-generated content.

The content is evaluated at block 704, for instance, to determine if the content satisfies certain requirements or message goals determined based on the insights. A refinement prompt is generated based on the content evaluation, as shown at block 706. For instance, it could be determined that the content generated at block 702 does not meet a particular requirement and the prompt is generated to refine the content to meet that particular requirement. As shown at block 708, the refinement prompt is provided as input to the generative model, which causes the generative model to generated refined content in accordance with instructions provided in the refinement prompt.

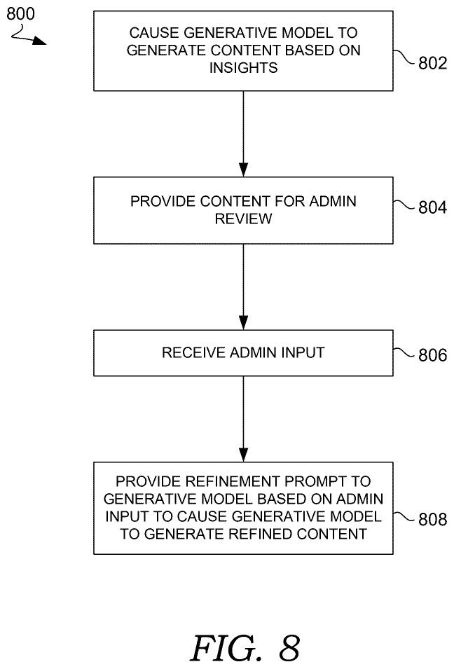

FIG. 8 is a flow diagram showing a method 800 for performing an admin review of generated content. As shown at block 802, a generative model is caused to generate content based on extracted insights. This could be, for instance, base content generated in accordance with blocks 604, 606, and 608 of FIG. 6, or refined content generated by the generative model refining previously-generated content.

The content is provided to an admin device for review by an administrative user, as shown at block 804. Input is received from the administrative user, as shown at block 806. For instance, the administrative user can review the content generated at block 802 and determine that certain changes should be made. In some instances, the input can simply be a rejection of the content or general indication that the content does not meet requirements for this end user. In some instances, the input can be specific instructions to modify the content a particular way or to meet a particular requirement. As shown at block 808, based on the admin input, a refinement prompt is provided to the generative model to cause the generative model to generate refined content.

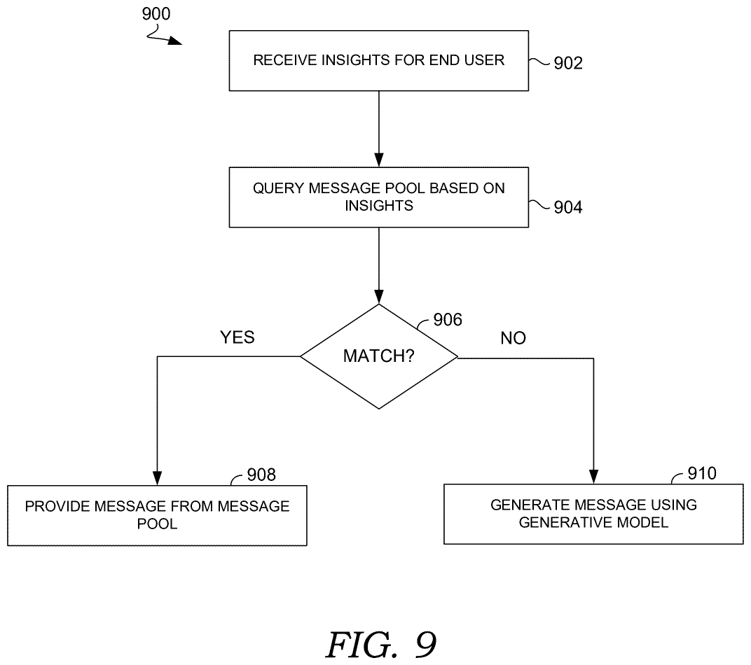

Turning next to FIG. 9, a flow diagram is provided showing a method 900 for employing a message pool. As shown at block 902, insights are received for an end user. For instance, user data for the end user could be accessed from a user data store (e.g., the user data store 124 of FIG. 1), and the insights extracted from the user data by the insight extraction component 114. A message pool (e.g., the message pool data store 126 of FIG. 1) is queried based on the insights for the end user, as shown at block 904. In some instance, this comprises generating a vector representation of the insights for the end user and determining a similarity of that vector representation with vector representations of insights stored in the message pool.

A determination is made at block 906 regarding whether these is a match returned from the query. The match could be based on, for instance, a similarity score between the vector representation for the end user and a stored vector representation satisfying a threshold similar score (or the stored vector representation with the highest similar score above the threshold). If a match is returned from the query, as shown at block 908, a message is provided based on a message or content stored in the message pool in association with the matching insight data. Alternatively, if a match is not returned from the query, as shown at block 910, a message is generated using the extracted insights (e.g., using the method 600 of FIG. 6).

### Exemplary Operating Environment

Having described implementations of the present disclosure, an exemplary operating environment in which embodiments of the present technology may be implemented is described below in order to provide a general context for various aspects of the present disclosure. Referring initially to FIG. 10 in particular, an exemplary operating environment for implementing embodiments of the present technology is shown and designated generally as computing device 1000. Computing device 1000 is but one example of a suitable computing environment and is not intended to suggest any limitation as to the scope of use or functionality of the technology. Neither should the computing device 1000 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 10, computing device 1000 includes bus 1010 that directly or indirectly couples the following devices: memory 1012, one or more processors 1014, one or more presentation components 1016, input/output (I/O) ports 1018, input/output components 1020, and illustrative power supply 1022. Bus 1010 represents what may be one or more busses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 10 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1012 includes computer storage media in the form of volatile and/or nonvolatile memory. The memory may be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which may be built in. Illustrative components include a microphone, joystick, game pad, satellite dish, scanner, printer, wireless device, etc. The I/O components 1020 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 1000. The computing device 1000 may be equipped with depth cameras, such as, stereoscopic camera systems, infrared camera systems, RGB camera systems, and combinations of these for gesture detection and recognition. Additionally, the computing device 1000 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
accessing user data for an end user;
extracting a plurality of insights from the user data;
generating a prompt using at least a portion of the plurality of insights;
causing a generative model to generate content using the prompt; and
providing a message to a user device of the end user based on the content from the generative model.

2. The one or more computer storage media of claim 1, wherein each insight comprises an attribute-value pair.

3. The one or more computer storage media of claim 2, wherein generating the prompt comprises employing a rule mapping a first attribute-value pair for a first insight to text for the prompt.

4. The one or more computer storage media of claim 1, wherein the operations further comprise:
generating a refinement prompt based on the content from the generative model; and
causing the generative model to generate refined content using the refinement prompt, wherein the message provided to the user device includes the refined content.

5. The one or more computer storage media of claim 4, wherein generating the refinement prompt comprises:
determining a requirement associated with a first insight of the plurality of insights is not met by the content; and
generating the refinement prompt to instruct the generative model to generate refined content to meet the requirement.

6. The one or more computer storage media of claim 4, wherein generating the refinement prompt comprises:
providing the content to a user device of an administrative user;
receiving input from the user device of the administrative user; and
generating the refinement prompt based on the input from the user device of the administrative user.

7. The one or more computer storage media of claim 1, wherein the operations further comprise:
storing the message in a message pool data store in association with first insight data based on at least a portion of the plurality of insights.

8. The one or more computer storage media of claim 7, wherein the operations further comprise:
comparing second insight data from a second plurality of insights for a second end user to the first insight data;
determining a similarity threshold is satisfied between the second insight data and the first insight data; and
responsive to determining the similarity threshold is satisfied, providing the message from the message pool data store to a user device of the second end user.

9. The one or more computer storage media of claim 8, wherein comparing the second insight data to the first insight data comprises:
generating a vector representation of the second insight data; and
computing a similarity score between the vector representation of the second insight data and a vector representation of the first insight data.

10. A computer-implemented method comprising:
determining, using an insight extraction component, a plurality of insights based on user data for a first end user;
generating, using a prompt generation component, a base prompt using the plurality of insights;
causing, by a content generation component, a generative model to generate base content using the base prompt;
generating, using the prompt generation component, a refinement prompt based on the base content;
causing, by the content generation component, the generative model to generate refined content using the refinement prompt; and
providing, to a user device of the first end user, a message generated based on the refined content.

11. The computer-implemented method of claim 10, wherein generating the base prompt comprises employing a rule mapping a first attribute-value pair for a first insight to text for the base prompt.

12. The computer-implemented method of claim 10, wherein generating the refinement prompt comprises:
determining a requirement associated with a first insight of the plurality of insights is not met by the base content; and
generating the refinement prompt to instruct the generative model to generate refined content to meet the requirement.

13. The computer-implemented method of claim 12, wherein the method further comprises:
providing the refined content to a user device of an administrative user; and
generating the message based on input received from the user device of the administrative user.

14. The computer-implemented method of claim 10, wherein generating the refinement prompt comprises:
providing the base content to a user device of an administrative user;
receiving input from the user device of the administrative user; and
generating the refinement prompt based on the input from the user device of the administrative user.

15. The computer-implemented method of claim 10, wherein the method further comprises:
storing the message in a message pool data store in association with first insight data based on at least a portion of the plurality of insights.

16. The computer-implemented method of claim 15, wherein the method further comprises:
comparing second insight data from a second plurality of insights for a second end user to the first insight data;
determining a similarity threshold is satisfied between the second insight data and the first insight data; and
responsive to determining the similarity threshold is satisfied, providing the message from the message pool data store to a user device of the second end user.

17. The computer-implemented method of claim 15, wherein comparing the second insight data to the first insight data comprises:
generating a vector representation of the second plurality of insights; and
computing a similarity score between the vector representation of the second plurality of insights and a vector representation of the plurality of insights.

18. A computer system comprising:
one or more processors; and
one or more computer storage media storing computer-useable instructions that, when used by the one or more processors, causes the computer system to perform operations comprising:
determining, by an insight extraction component, a plurality of insights from user data for an end user;
querying a message pool data store using first insight data for the plurality of insights;
based on not identifying stored insight data in the message pool data store with a threshold similarity to the first insight data, generating, by a prompt generation component, a base prompt using the plurality of insights;
causing, by a content generation component, a generative model to generate a base content using the base prompt;
responsive to determining the base content does not satisfy a requirement from the plurality of insights, generating, by the prompt generation component, a refinement prompt;
causing, by the content generation component, the generative model to generate a refined content using the refinement content; and
providing, by a content delivery component, a message generated based on the refined content.

19. The computer system of claim 18, wherein querying the message pool data store comprises:
generating a vector representation of the first insight data; and
computing a similarity score between the vector representation of the first insight data and a vector representation of at least one stored insight data in the message pool data store.

20. The computer system of claim 18, wherein the operations further comprise:
providing the refined content to a user device of an administrative user; and
generating the message based on input from the user device of the administrative user.
